(19) United States
(12) Patent Application Publication
(10) Pub. No.: US 2017/0120565 A1
(43) Pub. Date: May 4, 2017

(54) NATURAL FIBER VENEER COMPOSITE MATERIAL

(71) Applicants: Matthew Luciano Abbondanzio, San Diego, CA (US); Corey Canfield, Pleasant Prarie, WI (US); Diana Bagley, Milwaukee, WI (US)

(72) Inventors: Matthew Luciano Abbondanzio, San Diego, CA (US); Corey Canfield, Pleasant Prarie, WI (US); Diana Bagley, Milwaukee, WI (US)

(21) Appl. No.: 15/337,059

(22) Filed: Oct. 28, 2016

Related U.S. Application Data
(60) Provisional application No. 62/236,106, filed on Oct. 30, 2015.

(51) Int. Cl. B32B 21/14; B32B 9/02; B32B 27/40; B32B 5/02; B32B 7/12; B32B 3/26

(52) U.S. Cl. CPC B32B 21/14; B32B 7/12; B32B 3/266; B32B 27/40; B32B 5/022; B32B 9/02; B32B 2317/02

(57) ABSTRACT

New composite materials marrying natural veneers such as bamboo, wood, palm leaf etc to various substrates. Various embodiments include substrates such as repositionable adhesive, simple sealants or flexible thick rubber like materials. These composites are used for a variety of needs from kitchen cutting boards to temporary or semi-permanent surface coverings to new wooden fabric replacement for making soft goods such as bags, purses, containers, clothing etc.

### BACKGROUND OF THE INVENTION

The present invention was inspired by but is not limited to the identified consumer need gap between plastic food preparation cutting boards and solid wood food preparation cutting boards. This identified consumer need gap refers to the distance between consumers' desires to cut and prepare food for their meals on natural wood cutting boards and their need to keep themselves and their family safe from cross contamination that can occur with preparing certain foods such as poultry, meat etc. To mitigate this safety concern, consumers often use cutting boards and sheets made from plastic to prepare some or all of their foods as these plastic based products are often able to be placed in the dishwasher to be cleaned; a process that wood cutting boards typically are not able to be subjected to as a dishwasher will ruin them. Another advantage of plastic cutting sheets over solid wood cutting boards is that these plastic cutting sheets typically bend. This ability for sheets to bend and flex, allows consumers to easily pour their cut food into pots, pans or other receptacles rather than having to lift a heavy board with one and scrape the cut food into the receptacle with a utensil or their other hand. This process can be quite cumbersome and stressful on the user's wrist.

With all of the advantages of plastic cutting boards and sheets over solid wood cutting boards, there remains the problem that the experience of using a plastic cutting board or sheet is often undesirable due to the over all user experience, aesthetics etc. It has been found through ethnographic consumer research that cutting on plastic boards and sheets can undesirable, the plastic can slip easily on a counter creating a potential danger and these plastic boards and sheets can become easily stained and warped over time. Through research it was found that the desire to use a wood cutting surface was so great that consumers will often prepare poultry and other potentially dangerous foods on their wood cutting boards and assume the risk that comes with hand washing these boards in their sink with soap and water. It should also be noted that this process of washing wood cutting boards, especially larger ones can be quite challenging as most boards do fit into typical sized sinks.

### BRIEF DESCRIPTION OF THE DRAWINGS

FIG. 1 is a drawing of a partial view of the assembly of an embodiment of the disposable veneer composite sheet with repositionable adhesive.

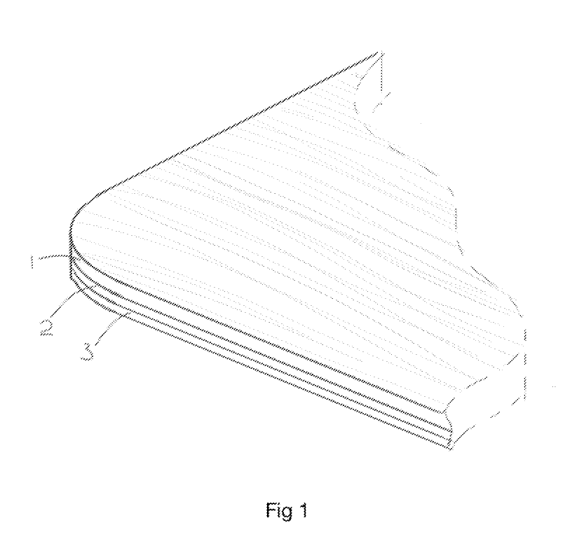

FIG. 2 is a drawing of a partial view of an exploded view of an embodiment of the disposable veneer composite sheet with repositionable adhesive.

FIG. 3 is a drawing of a partial view of the assembly of an embodiment of the disposable veneer composite sheet with a sealant applied to the back side of the veneer.

FIG. 4 is a drawing of a partial view of the assembly of an embodiment of the flexible durable veneer composite sheet with repositionable adhesive.

FIG. 5 is a drawing of a partial view of an exploded view of an embodiment of the flexible durable veneer composite sheet with repositionable adhesive.

FIG. 6 is a partial view of the underside of FIG. 1 showing the use of a perforated release liner.

### DETAILED DESCRIPTION OF THE INVENTION

Though the described invention's initial goal was to solve this experiential gap between plastic and wood cutting boards, the solution described in this patent has many more applications beyond this one problem. What is being described in this patent are two new related composite materials.

In one embodiment of the composite material being patented (referred from this point on as a “disposable veneer composite sheet”) consists of applying a repositionable adhesive, 2 & 5 & 17 to a wood, bamboo or other natural veneer 1 & 4 other than paper or paper like materials, with or without the further application of a release liner 3 & 6 & 15 on the exposed adhesive 17. This disposable veneer composite sheet may be used as a thin multi-use natural wood like cutting surface for food preparation. The adhesive 17, if used by the consumer, will keep the cutting sheet from moving during use while still allowing the user to easily pick the sheet up to pour its contents and re-adhere it to a counter or other surface. This action is similar to a 3M Post-It note. The disposable veneer composite sheet, preferably made of a bamboo veneer, may be used numerous times but may also be disposed of after any particular use such as cutting chicken on it to mitigate the chance of cross contamination of food born illness such as salmonella. The disposal of the disposable veneer composite sheet is more likely to occur if the disposable veneer composite sheet is made of a renewable material such as bamboo, palm leaves or the like. Other uses of this disposable veneer composite sheet could be to semi-permanently or temporarily cover flat or curved surfaces with a natural or wood veneer to obtain a natural wood look without the need to permanently apply a veneer to a surface as is normally done with wood veneers on furniture.

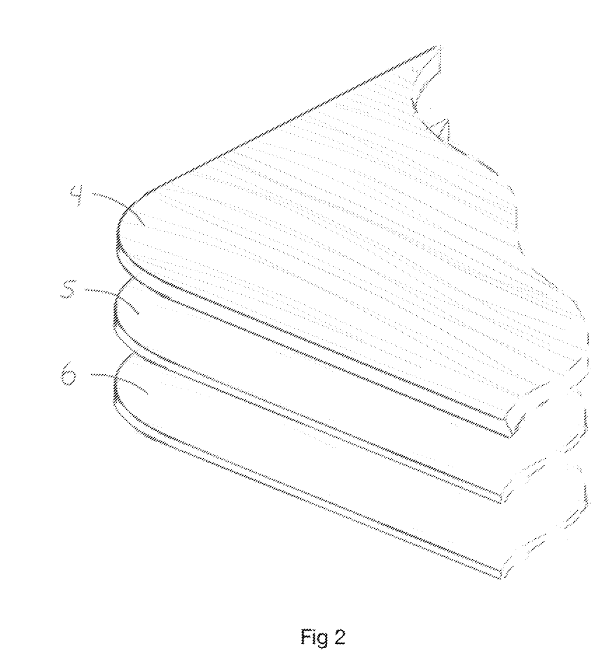

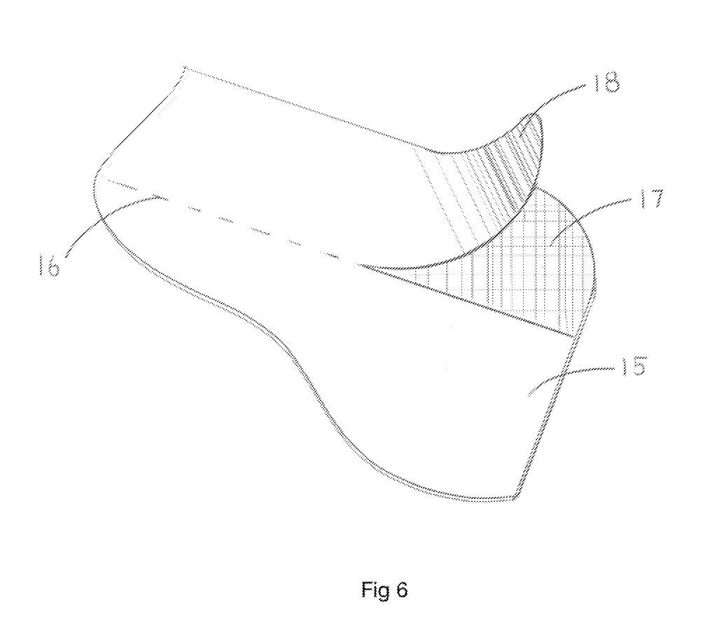

As Shown in FIG. 2 and FIG. 6, this disposable veneer composite sheet can be made by taking a thin natural veneer 4 and either applying a repositionable adhesive 5 to the back side of the veneer 4 using either spray method or by using a double sided pressure sensitive (PSA) adhesive where one side of the PSA, shown as the “top” side of 5, will permanently adhere to the natural veneer 4 and the other side of the PSA, shown as the “bottom” (not visible) side of 5, is repositionable adhesive that temporarily, yet in a repeatable manner, adheres to a variety of surfaces such as ceramic, stone, metal, plastic etc. It is not intended that the repositionable side of the PSA adhere to low energy materials such as polyethylene or polypropylene. This adhesive serves two purposes. The first purpose of the adhesive, regardless of application manner, is to allow users to adhere the disposable veneer composite sheet to a multitude of surfaces, easily remove it from that surface and then re-adhere it to another surface multiple times. The second purpose of the adhesive it to seal the natural veneer inhibiting or eliminating the flow of liquid through it. An example use case of this sealing purpose would be to block food liquids or juices from seeping through the veneer onto the surface it has been adhered to. The benefit of this is to limit the propagation of a liquid mess and to not allow the liquid to reduce the effectiveness of the adhesive. The veneer and adhesive assembly can then be laser cut, die cut or similar to cut the sheet into a given shape and size. A release liner 6 & 15 may be applied before cutting the veneer and adhesive assembly into shape or it may be die cut to shape separately and then applied to the veneer adhesive assembly with the use of a jig or other manual or automated process using a registration system such as optical or physical registration marks or features. A post pressing or rolling process may then be used to remove air bubbles from the veneer, adhesive and release liner assembly. The release liner 6 & 15 is meant to cover and protect the repositionable adhesive until it is ready for use by the consumer. The release liner will easily be removed 18 from the assembly exposing the repositionable adhesive 17 for use. This release liner may or may not be printed on and may or may not have sections that allow a user to remove a portion 18 of the release liner to control how much adhesive is exposed. An example of this may be cutting a perforated line 16 or curve into the release liner before or after the release liner is applied to the veneer and adhesive assembly.

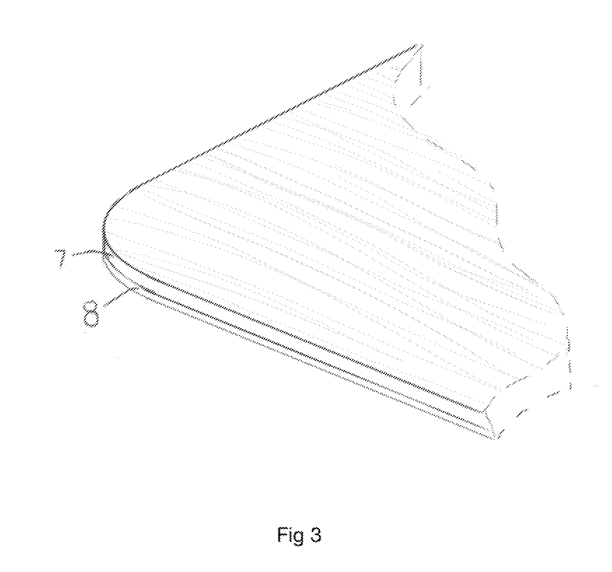

As shown in FIG. 3, a second embodiment of the disposable veneer composite sheet is made by sealing the back side of the veneer 7 with a sealant 8 such polyurethane or a similar coating rather than applying an adhesive as in the first embodiment of the disposable veneer composite. The reason to seal the back surface of the natural veneer is to inhibit or eliminate the flow of liquid through it just as in the first embodiment. An example use case of this sealing purpose would be to block food liquids or juices from seeping through the veneer onto the surface it has been placed. This primary purpose of the second embodiment of the disposable veneer composite sheet is to offer a lower cost version of the first embodiment of the disposable veneer composite sheet that can be used as a low cost disposable natural, preferably bamboo, cutting surface that prevents fluid flow through the veneer and a way for consumers to prepare food on a natural surface which is cost effective enough to be easily disposed to prevent cross contamination.

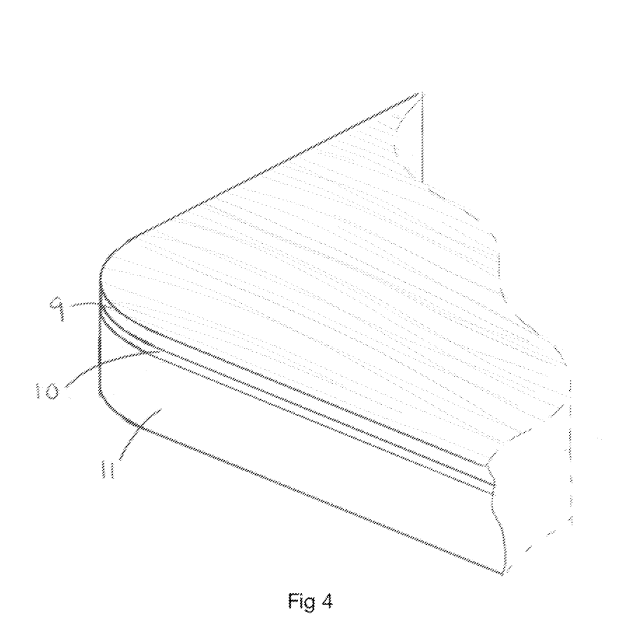

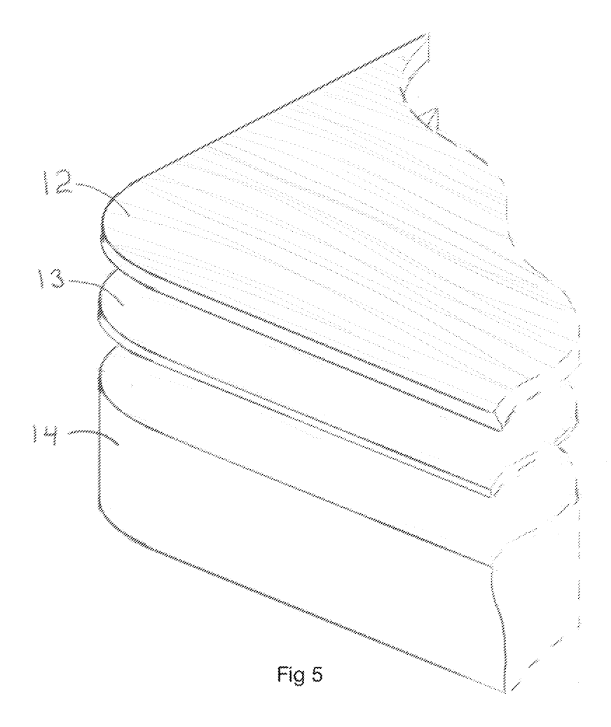

As shown in FIG. 4 and FIG. 5, the second composite material (referred from this point on as a “flexible durable veneer composite”) consists of applying a flexible rubber or rubber like material or substrate 11 & 14 to thin wood or natural fiber veneer 9 & 12. The flexible rubber like material may be of a variety of materials however silicone, neoprene or nitrile are preferable due to the chemical resistant nature of these materials. The attachment method of the natural veneer to the flexible substrate may also be with a variety of adhesives 10 & 13, however preference is to use a permanent adhesive to keep the natural veneer securely attached to the flexible substrate. For the case of a silicone rubber substrate, silicone adhesive is highly preferable. Once the adhesive has cured, this flexible durable veneer composite will have to features. 1) the flexible durable veneer composite will flex, bend and even roll depending on the durometer and thickness of the substrate 11 & 14. 2) with the flexible durable veneer composite lying flat on a rigid surface such as a kitchen counter top, the density of the substrate will allow for a significant amount of pressure to be locally applied to the veneer 9 & 12 surface without significant flexural damage to the veneer such as when a kitchen knife is applied to the surface in the process of cutting food for meal preparation.

This flexible durable veneer composite will be made by laser or die cutting or other similar method to cut and form the natural, preferably wood, veneer into a specific shape. The flexible substrate that can be made of a variety of materials but preferably a rubber and preferable silicone for kitchen applications will be cut to shape by a laser cutting, die cutting or similar process to a desired shape, preferably to the same shape as the veneer is cut to. However there may be reasons to make these shapes not match. Based on the substrate material 11 & 14, appropriate adhesive 10 & 13 that will adhere both to the natural veneer 9 & 12 and the flexible substrate 11 & 14 material will be applied to either the back of the veneer or to one of the surfaces of the flexible substrate or preferably both if the adhesive is in a spray or liquid or semi-liquid form. A double sided pressure sensitive adhesive 10 & 13 may also be used and applied to one or both materials. The veneer and substrate will be assembled to each other, preferably with the use of a jig or other manual or automated process that uses a registration system such as optical or physical registration marks or features to align the parts in the desired relative position. A post pressing or rolling process may then be used to remove air bubbles from the veneer and substrate assembly.

This flexible durable veneer composite has a variety of uses. The initial use case for this new material is to provide a new type of cutting board that is both made of a natural material such as wood and flexes like a plastic cutting sheet. This composite provides consumers with the desired ability to cut on a natural, preferable wood, cutting board while allowing them to easily pick up this cutting board, bend or flex this board and easily pour the food contents into a receptacle such as a pot or pan. In addition, this flexible durable veneer composite used as a cutting board and cut into a large shape similar to large solid wood cutting boards allows the user to easily clean it in a typical kitchen sink as it will bend and conform to the sink unlike large rigid solid wood or plastic cutting board. Other uses may be as temporary or semi-permanent removable surface coverings such as outdoor or older furniture, placemats etc. This composite may also be used as a building material for soft goods creating new soft wooden bags, purses, containers clothing etc.

What is claimed is:

1. A composite material comprising:
a veneer made of bamboo, wood or other natural material with adhesive permanently attached to one side of the veneer where the other side of the adhesive is repositionable.

2. A composite material as claimed in claim 1 wherein a paper release liner is applied to the exposed adhesive

3. A composite material as claimed in claim 1 wherein a paper release liner is applied to the exposed adhesive and incorporates perforated cuts to allow separation of a portion of the release liner

4. A composite material as claimed in claim 1 wherein a non-paper release liner is applied to the exposed adhesive

5. A composite material as claimed in claim 1 wherein a non-paper release liner is applied to the exposed adhesive and incorporates perforated cuts to allow separation of a portion of the release liner

6. A composite material comprising:
a veneer made of bamboo, wood or other natural material sealed on the back side to eliminate fluid flow or seepage through the veneer.

7. A composite material as claimed in claim 6 wherein the material used to seal the back of the veneer is a thermoset polymer such as polyurethane or similar

8. A composite material as claimed in claim 6 wherein the material used to seal the back of the veneer is an elastomer such as RTV or similar

9. A composite material as claimed in claim 6 wherein the material used to seal the back of the veneer is a thermoplastic such as polypropylene or similar

10. A composite material comprising:
a veneer made of bamboo, wood or other natural material permanently attached to a flexible substrate

11. A composite material as claimed in claim 10 wherein the flexible substrate material is an elastomeric rubber compound such as silicone, nitrile or neoprene.

12. A composite material as claimed in claim 10 wherein the flexible substrate material is a natural fabric weave

13. A composite material as claimed in claim 10 wherein the flexible substrate material is a natural fabric weave

14. A composite material as claimed in claim 10 wherein the flexible substrate material is a plastic non-woven fabric

15. A composite material as claimed in claim 10 wherein the flexible substrate material is a natural fiber non-woven fabric

16. A composite material as claimed in claim 10 wherein the flexible substrate material is a natural fiber such as cork or similar

17. A composite material as claimed in claim 10 wherein the substrate material is not flexible
